(19) United States
(12) Patent Application Publication
(10) Pub. No.: US 2018/0365295 A1
(43) Pub. Date: Dec. 20, 2018

(54) Tuning Parameters for Presenting Content

(71) Applicant: Google Inc., Mountain View, CA (US)

(72) Inventors: Matthew Paff, Mountain View, CA (US); Gaurav Garg, San Francisco, CA (US); Ramakrishnan Kandhan, Mountain View, CA (US); Awaneesh Verma, San Francisco, CA (US); Chetan Narain, San Francisco, CA (US); Omkar Muralidharan, Sunnyvale, CA (US); Mehmet Emre Sargin, Sunnyvale, CA (US); Ming Yang, Sunnyvale, CA (US); David Adams, Burlingame, CA (US)

(73) Assignee: Google Inc., Mountain View, CA (US)

(21) Appl. No.: 14/071,317

(22) Filed: Nov. 4, 2013

(51) Int. Cl. G06F 17/30

(52) U.S. Cl. CPC G06F 17/30522

(57) ABSTRACT

Methods, systems, and apparatus include computer programs encoded on a computer-readable storage medium, including a method for providing content. One or more content items are identified that are eligible to be presented in response to received requests in accordance with one or more selection criteria. One of the content items includes one or more parameters that can be varied. A range is identified over which a parameter of the one or more parameters is variable, and a subset of the range is identified, wherein the subset is less than the entire range. A request for content is received that is satisfied by the content item. The content item is prepared, including randomly selecting a value for the parameter that is within the subset of the range. At least one performance aspect associated with the prepared one content item is monitored.

### BACKGROUND

This specification relates to information presentation.

The Internet provides access to a wide variety of resources. For example, video and/or audio files, as well as webpages for particular subjects or particular news articles, are accessible over the Internet. Access to these resources presents opportunities for other content (e.g., advertisements) to be provided with the resources. For example, a webpage can include slots in which content can be presented. These slots can be defined in the webpage or defined for presentation with a webpage, for example, along with search results.

Content slots can be allocated to content sponsors as part of a reservation system, or in an auction. For example, content sponsors can provide bids specifying amounts that the sponsors are respectively willing to pay for presentation of their content. In turn, an auction can be run, and the slots can be allocated to sponsors according, among other things, to their bids and/or a likelihood that the user will interact with the content presented. Parameters used for the presentation of content can be set at specific values or settings in order to improve the likelihood that users will react with the content.

### SUMMARY

In general, one innovative aspect of the subject matter described in this specification can be implemented in methods that include a computer-implemented method for monitoring performance of content. The method includes identifying one or more content items that are eligible to be presented in response to received requests in accordance with one or more selection criteria, wherein one of the content items includes one or more parameters that can be varied. The method further includes identifying a range over which a parameter of the one or more parameters is variable, and a subset of the range, wherein the subset is less than the entire range. The method further includes receiving a request for content satisfied by the content item. The method further includes preparing the content item including randomly selecting a value for the parameter that is within the subset of the range. The method further includes monitoring at least one performance aspect associated with the prepared one content item.

These and other implementations can each optionally include one or more of the following features. One or more parameters can relate to a presentation aspect of the content item. The presentation aspect can be selected from the group comprising a color of an item, a font width, or a size of a respective content item. The presentation aspect can be a color of a link or a visual uniform resource locator (visURL) associated with the content item. The method can further include running an experiment to determine an optimal value for the variable in the subset of the range and adjusting the parameters associated with the content item based on the determined optimal value. Monitoring can include evaluating whether the content item is selected as a winner in a selection process and is presented in response to the received request. The method can further include, based on the monitoring, adjusting the subset of the range iteratively until an optimal value for the variable is determined. Adjusting the subset of the range can include reducing a size of the subset of the range and repeating the preparing based on received requests that satisfy the selection criteria associated with the content item. The method can further include estimating an optimal value for the variable in the subset of the range and running an experiment using the estimated optimal value while iterating to determine an actual optimal value based on the adjusting and monitoring. Monitoring can include monitoring revenue or quality metrics based on the randomly-selected values and automatically tuning the subset of the range iteratively so as to locate an optimal value for the variable.

In general, another innovative aspect of the subject matter described in this specification can be implemented in computer program products that include a computer program product tangibly embodied in a computer-readable storage device and comprising instructions. The instructions, when executed by one or more processors, cause the processor to: identify one or more content items that are eligible to be presented in response to received requests in accordance with one or more selection criteria, wherein one of the content items includes one or more parameters that can be varied; identify a range over which a parameter of the one or more parameters is variable, and a subset of the range, wherein the subset is less than the entire range; receive a request for content satisfied by the content item; prepare the content item including randomly selecting a value for the parameter that is within the subset of the range; and monitor at least one performance aspect associated with the prepared one content item.

These and other implementations can each optionally include one or more of the following features. The computer program product can further include instructions to run an experiment to determine an optimal value for the variable in the subset of the range, and adjusting the parameters associated with the content item based on the determined optimal value. Monitoring can include adjusting the subset of the range iteratively until an optimal value for the parameter is determined. Adjusting the subset of the range can include reducing a size of the subset of the range and repeating the preparing based on received requests that satisfy the selection criteria of the associated with the content item. Monitoring can include monitoring revenue or quality metrics based on the randomly-selected values and automatically tuning the subset of the range iteratively so as to locate an optimal value for the parameter.

In general, another innovative aspect of the subject matter described in this specification can be implemented in systems, including a system for monitoring the presentation of content. The system includes a content identification engine for identifying one or more content items that are eligible to be presented in response to received requests in accordance with one or more selection criteria, wherein one of the content items includes one or more parameters that can be varied. The system further includes a range identification engine for identifying a range, including at least one subset of the range (e.g., a sub-range) that is less than the entire range, for varying a value of a parameter of the one or more parameters associated with presentation of the content item. The system further includes a request handler for receiving a request for content and identifying one or more content items that satisfy the request. The system further includes a parameter varying engine for preparing the content item, including randomly selecting a value for the parameter that is within the subset of the range. The system further includes a performance monitoring engine for monitoring at least one performance aspect associated with the prepared content item.

These and other implementations can each optionally include one or more of the following features. Monitoring can include adjusting the subset of the range iteratively until an optimal value for the parameter is determined. Adjusting the subset of the range can include reducing a size of the subset of the range and repeating the preparing based on received requests that satisfy the selection criteria of the associated with the content item. Monitoring can include monitoring revenue or quality metrics based on the randomly-selected values and automatically tuning the subset of the range iteratively so as to locate an optimal value for the parameter.

Particular implementations may realize none, one or more of the following advantages. Experimentation using different values of presentation parameters for content items can occur automatically. Using performance metrics, optimal values can be determined automatically for presentation parameters.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for delivering content.

FIG. 2A shows an example system for randomly varying parameters associated with the presentation of content.

FIG. 2B shows an example process for experimenting with parameters for presentation of content.

FIG. 3 is a flowchart of an example process for experimenting with values of presentation parameters for content items.

FIG. 4 is a block diagram of an example computer system that can be used to implement the methods, systems and processes described in this disclosure.

Like reference numbers and designations in the various drawings indicate like elements.

### DETAILED DESCRIPTION

This document describes systems, methods, computer program products and mechanisms for automatically using random (or pseudo random) values for parameters used in the presentation of content items. For example, for any particular parameter, a sub-range (subset of a range) of values can be defined, and a random value within that range can be chosen to prepare a content item responsive to a request. This can occur, for example, for a small percentage of traffic. Additional requests for the same content item can lead to the automatic selection and use of different randomly-chosen values for the parameter. The process can be repeated using many random values, and the results can be monitored over time so that better performing sub-ranges and/or an optimal value can be determined. Optimal values can be tested using experiments, and values that perform well can be launched as new default values, e.g., to be used going forward for the complete set of requests for content. Other types of experimentation can occur, including to determine optimal combinations of values. For example, experimentation can occur on one or more of various text colors, including link and visual (or visible) universal resource locator (visURL) colors, text font, text size, background colors of advertisement blocks, colors used in ratings stars, and spacing between various blocks of text. While examples provided herein apply to changing parameters for a single content item, the same parameter changes can be used for some or all content items on a same page or across a campaign or based on some other grouping. For example, changes to parameters can be consistent across a web page, e.g., all advertisements or all search results on the web page can use the same colors for each of link color and visURL color.

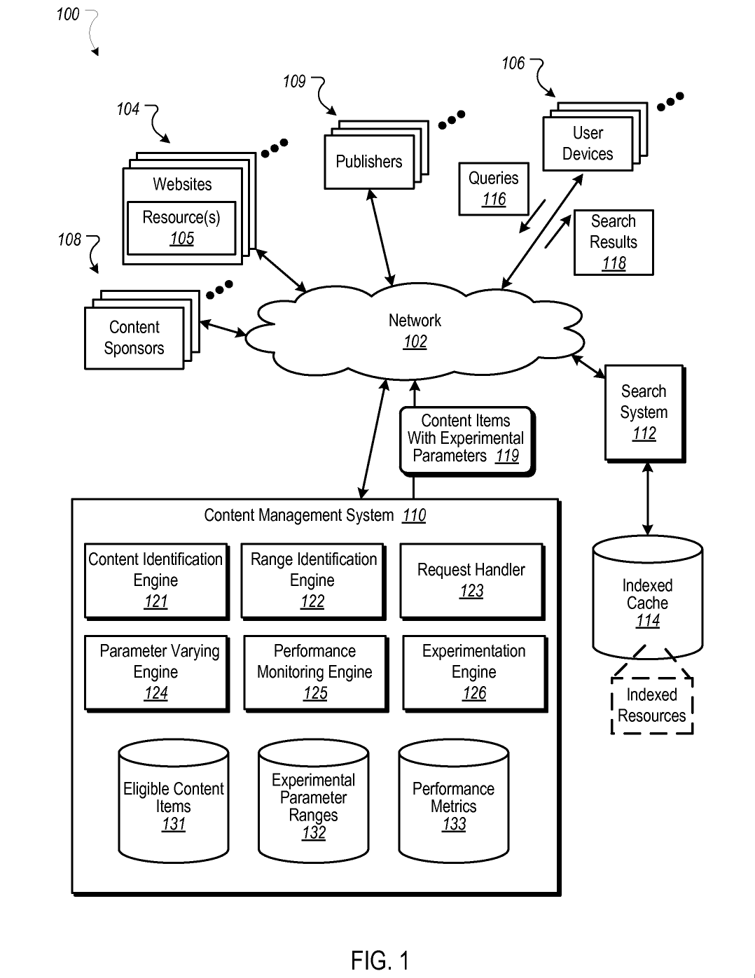

FIG. 1 is a block diagram of an example environment 100 for delivering content. The example environment 100 includes a content management system 110 for selecting and providing content in response to requests for content. The example environment 100 includes a network 102, such as a local area network (LAN), a wide area network (WAN), the Internet, or a combination thereof. The network 102 connects websites 104, user devices 106, content sponsors 108 (e.g., advertisers), publishers 109, and the content management system 110. The example environment 100 may include many thousands of websites 104, user devices 106, content sponsors 108 and publishers 109.

In some implementations, the content management system 110 can provide content items 119 that are configured prior to delivery based on a selection (e.g., a random selection) for a parameter (such as a presentation parameter). For example, individual instances of the content items 119 can be prepared and served based on a different randomly-chosen value, e.g., chosen from a sub-range of possible values, for a given parameter.

The environment 100 can include plural data stores, which can be stored locally by the content management system 110, stored somewhere else and accessible using the network 102, generated as needed from various data sources, or some combination of these. A repository of eligible content items 131, for example, can include various content items that can be presented within the environment 100. In some implementations, the eligible content items 131 can include advertisement creatives in campaigns defined by content providers 108 that include advertisements selectable for presentation to users. In some implementations, the eligible content items 131 can also include search results that can be identified as responsive to a search query or some other request for content that originates from user devices 106 or other sources. Other types of eligible content items 131 are possible, including content that is provided in social networks.

In some implementations, the parameters that are chosen for the content items can vary by the intended destination of the content item, e.g., whether the content item is being presented as search results in a browser, or an advertisement on a social network page, a web page, or other location. In some implementations, the parameters that are chosen can vary by demographic, e.g., providing a different color scheme to one group of users versus another group. Other special ways of varying the parameters can be used.

A data store of experimental parameter ranges 132, for example, can include ranges of values for parameters that can be used in experimentation. Example parameters can include presentation parameters, such as parameters that affect some aspect of the presentation of a given content item that has been selected for delivery responsive to a received request. For color-related parameters, for example, the ranges can be numeric values (e.g., hex or integer codes representing values from 0 to 255) from which different random values can be selected for presentation of content items in response to a portion of the received requests. In some implementations, ranges of values can be non-integer ranges, date/time ranges, distance values (e.g., for experimenting on presenting content based on location), price-based ranges, or other values and ranges or values. In some implementations, where continuous ranges are not feasible (e.g., enumeration types), ranges can include discrete sets or subsets or values, e.g., the names of the days of the week, the names of states, specific numeric values that don't follow a range, or other lists. Other types of parameters can be experimented with in accordance with the methods provided. Examples of other types of parameters include data file names, e.g., for experimenting with different values for parameters associated with data files.

The content management system 110 can include plural engines. A content identification engine 121, for example, can identify one or more content items that are eligible to be presented in response to received requests in accordance with one or more selection criteria, wherein one of the content items includes one or more parameters that can be varied. For example, some content items may be defined or designated not to use random values for parameters, and other content items may have already undergone experimentation in order to identify optimal vales.

A range identification engine 122, for example, can identify a range, including at least one subset of the range (e.g., a sub-range) that is less than the entire range, for varying a value of a parameter of the content item. As an example, for a parameter that is a red color component of an element of a content item (e.g., a visual URL in search results), the range identification engine 122 can identify a range of 215-245 as a sub-range of an available range of 0-255. This identified range can then be used to select from when choosing a random value for the parameter (e.g., the visual URL). In some implementations, the ranges for the colors can be specified in a different color-space other than RGB, such as hue, saturation and lightness (HSL) coordinates associated with an HSL color space.

A request handler 123, for example, can receive a request for content and identify one or more eligible content items that satisfy the request, including the one content item. The identification can be based on information in the request, e.g., search query terms, criteria for a content item slot, or other selection criteria.

A parameter varying engine 124, for example, can prepare the one content item, including randomly selecting a value for the parameter that is within the subset of the range. For example, if the sub-range of available red color component is 215-245, then the parameter varying engine 124 can select one of the thirty-one values (e.g., 229) in the range. Subsequent requests for content (e.g., for the same content item) can result in the selection of a different value (e.g., 234) in the 215-245 range. In some implementations, identifiers (e.g., cookies) or some other technique can be used so that requests from the same user will use the same selection of presentation parameters as the previous query for that user. In this example, requests from different users would result in a new random selection of presentation parameters.

A performance monitoring engine 125, for example, can monitor at least one performance aspect associated with the prepared one content item. For example, for each of the possible values in the range, the performance monitoring engine 125 can identify and track performance metrics related to quality, revenue and/or other performance aspects related to performance of respective instantiations of the content item. In some implementations, monitoring as described herein can occur at the content item level, or monitoring can occur in aggregate, e.g., to monitor performance aspects for click-through rates for some or all content items associated with one or more parameter values.

An experimentation engine 126, for example, can run an experiment to determine an optimal value for a parameter, and can adjust the parameters associated with the content item based on the determined optimal value. For example, in response to plural requests for content that are satisfied by a content item, the experimentation engine 126 can select different random values from a specific sub-range for the parameter of the content item and use performance-based monitoring information to narrow the sub-range for use in subsequent experimentation. Similarly, other sub-ranges can be selected so that an optimal value across the broader range can be identified.

A website 104 includes one or more resources 105 associated with a domain name and hosted by one or more servers. An example website is a collection of webpages formatted in hypertext markup language (HTML) that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources include HTML pages, word processing documents, portable document format (PDF) documents, images, video, and news feed sources, to name only a few. The resources can include content, such as words, phrases, images, video and sounds, that may include embedded information (such as meta-information hyperlinks) and/or embedded instructions (such as JavaScript™ scripts).

A user device 106 is an electronic device that is under control of a user and is capable of requesting and receiving resources over the network 102. Example user devices 106 include personal computers (PCs), televisions with one or more processors embedded therein or coupled thereto, set-top boxes, mobile communication devices (e.g., smartphones), tablet computers and other devices that can send and receive data over the network 102. A user device 106 typically includes one or more user applications, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display, such as a presentation location of a pop-up window or a slot of a third-party content site or webpage, in which content can be presented. These specified portions of the resource or user display are referred to as slots (e.g., ad slots).

To facilitate searching of these resources, the environment 100 can include a search system 112 that identifies the resources by crawling and indexing the resources provided by the content publishers on the websites 104. Data about the resources can be indexed based on the resource to which the data corresponds. The indexed and, optionally, cached copies of the resources can be stored in an indexed cache 114.

User devices 106 can submit search queries 116 to the search system 112 over the network 102. In response, the search system 112 can, for example, access the indexed cache 114 to identify resources that are relevant to the search query 116. The search system 112 identifies the resources in the form of search results 118 and returns the search results 118 to the user devices 106 in search results pages. A search result 118 can be data generated by the search system 112 that identifies a resource that is provided in response to a particular search query, and includes a link to the resource. In some implementations, the search results 118 include the content itself, such as a map, or an answer, such as in response to a query for a store's products, phone number, address or hours of operation. In some implementations, the content management system 110 can generate search results 118 using information (e.g., identified resources) received from the search system 112. An example search result 118 can include a webpage title, a snippet of text or a portion of an image extracted from the webpage, and the URL of the webpage. Search results pages can also include one or more slots in which other content items (e.g., ads) can be presented. In some implementations, slots on search results pages or other webpages can include content slots for content items that have been provided as part of a reservation process. In a reservation process, a publisher and a content item sponsor enter into an agreement where the publisher agrees to publish a given content item (or campaign) in accordance with a schedule (e.g., provide 1000 impressions by date X) or other publication criteria. In some implementations, content items that are selected to fill the requests for content slots can be selected based, at least in part, on priorities associated with a reservation process (e.g., based on urgency to fulfill a reservation).

When a resource 105, search results 118 and/or other content are requested by a user device 106, the content management system 110 receives a request for content. The request for content can include characteristics of the slots that are defined for the requested resource or search results page, and can be provided to the content management system 110.

For example, a reference (e.g., URL) to the resource for which the slot is defined, a size of the slot, and/or media types that are available for presentation in the slot can be provided to the content management system 110 in association with a given request. Similarly, keywords associated with a requested resource (“resource keywords”) or a search query 116 for which search results are requested can also be provided to the content management system 110 to facilitate identification of content that is relevant to the resource or search query 116.

Based at least in part on data included in the request, the content management system 110 can select content that is eligible to be provided in response to the request (“eligible content items”). For example, eligible content items can include eligible ads having characteristics matching the characteristics of ad slots and that are identified as relevant to specified resource keywords or search queries 116. In some implementations, the selection of the eligible content items can further depend on user signals, such as demographic signals and behavioral signals.

The content management system 110 can select from the eligible content items that are to be provided for presentation in slots of a resource or search results page based at least in part on results of an auction (or by some other selection process). For example, for the eligible content items, the content management system 110 can receive offers from content sponsors 108 and allocate the slots, based at least in part on the received offers (e.g., based on the highest bidders at the conclusion of the auction or based on other criteria, such as those related to satisfying open reservations and a value of learning). The offers represent the amounts that the content sponsors are willing to pay for presentation (or selection or other interaction with) of their content with a resource or search results page. For example, an offer can specify an amount that a content sponsor is willing to pay for each 1000 impressions (i.e., presentations) of the content item, referred to as a CPM bid. Alternatively, the offer can specify an amount that the content sponsor is willing to pay (e.g., a cost per engagement) for a selection (i.e., a click-through) of the content item or a conversion following selection of the content item. For example, the selected content item can be determined based on the offers alone, or based on the offers of each content sponsor being multiplied by one or more factors, such as quality scores derived from content performance, landing page scores, a value of learning, and/or other factors.

A conversion can be said to occur when a user performs a particular transaction or action related to a content item provided with a resource or search results page. What constitutes a conversion may vary from case-to-case and can be determined in a variety of ways. For example, a conversion may occur when a user clicks on a content item (e.g., an ad), is referred to a webpage, and consummates a purchase there before leaving that webpage. A conversion can also be defined by a content provider to be any measurable or observable user action, such as downloading a white paper, navigating to at least a given depth of a website, viewing at least a certain number of webpages, spending at least a predetermined amount of time on a web site or webpage, registering on a website, experiencing media, or performing a social action regarding a content item (e.g., an ad), such as republishing or sharing the content item. Other actions that constitute a conversion can also be used.

For situations in which the systems discussed here collect information about users, or may make use of information about users, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that certain information about the user is removed. For example, a user's identity may be treated so that no identifying information can be determined for the user, or a user's geographic location may be generalized where location information is obtained (such as to a city, ZIP code, or state level), so that a particular location of a user cannot be determined. Thus, the user may have control over how information is collected about the user and used by a content server.

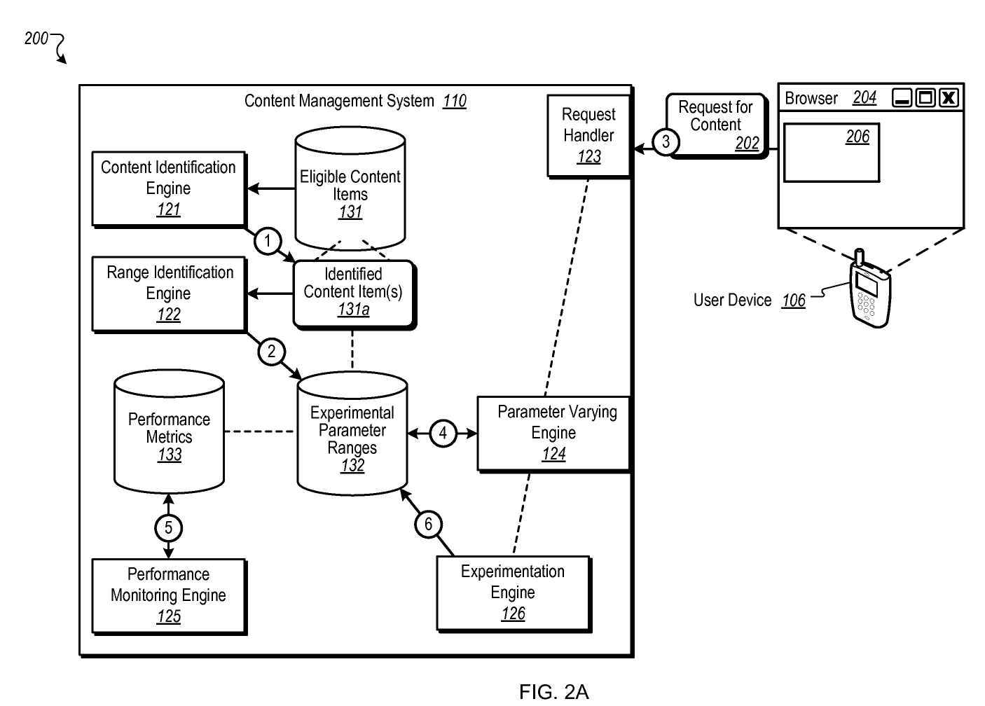

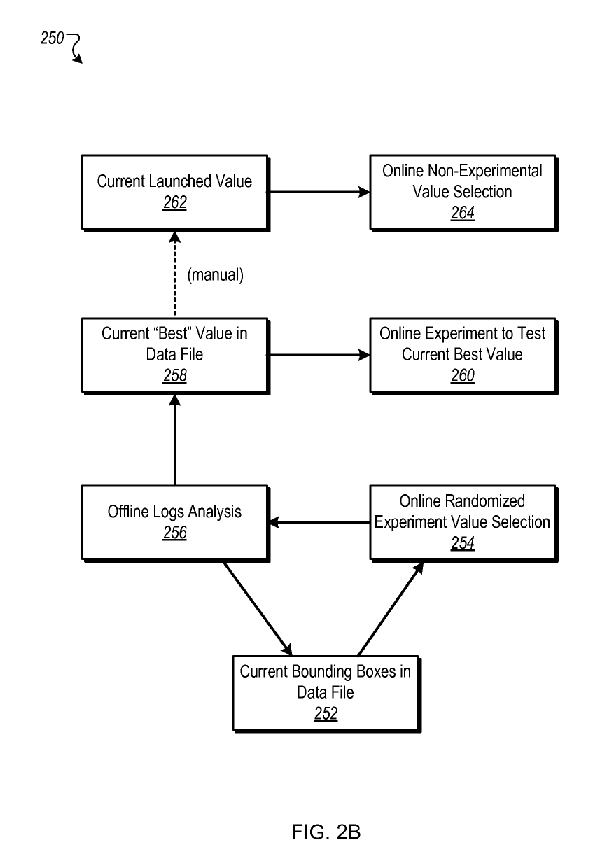

FIG. 2A shows an example system 200 for randomly varying parameters associated with the presentation of content. For example, the system 200 can be used to randomly vary presentation parameters associated with content items (e.g., advertisements) provided in the environment 100. In an example, the varying can be applied to two elements of a content item, such as the result link color and the visual universal resource locator (visURL) color that are used for presentation of search results. In this example, each of the elements (e.g., result link and visURL) is made up of three colors, or three separate parameters, including one parameter each for the component shades of red, blue and green. As a result, varying presentation parameters associated with the colors of the two elements is a matter of varying six presentation parameters. Each presentation parameter can be varied over a range, sub-ranges can be selected, and individual values within a sub-range can be assigned randomly or pseudo-randomly, for example, each time an opportunity occurs to present the content item (e.g., wherein an opportunity may be only a portion of the time that the content item is served).

At stage 1, for example, the content identification engine 121 can identify one or more content items that are eligible to be presented in response to received requests in accordance with one or more selection criteria, wherein one or more parameters associated with the one or more content items can be varied. For example, the content identification engine 121 can identify the content item 131a (e.g., search results) from the eligible content items 131. The identification may be made, for example, for eligible content items that are new and for which it is not yet known what effect may occur by varying parameters associated with the presentation of the content item 131a. In the current example, the content identification engine 121 can identify the search results as the content for which to vary the result link color and the visURL color, e.g., six color component-related parameters in all.

At stage 2, for example, the range identification engine 122 can identify a range, including at least one subset of the range (e.g., a sub-range) that is less than the entire range, for varying a value of a parameter of the one or more parameters associated with presentation of the content item. As an example, while the full range of possible values for each of red-green-blue (RGB) components can be 0 to 255, the range identification engine 122 can identify sub-ranges of starting RGB values. For example, for a result link color (e.g., for ranges that include lavender), the red, green and blue value ranges can be 210-250, 210-250 and 240-255, respectively. The starting RGB ranges for a sandy brown-colored visURL, for example, can be 212-252, 140-180, and 130-160. These are just examples of sub-ranges for colors, as other combinations are possible for any color scheme. Further, colors are just one example of parameters that can be varied and for which ranges and sub-ranges can be selected. Other examples of presentation parameters that can be varied include a color of an item, a font, a font width and/or height, or a size of a respective content item.

In some implementations, ranges can be automatically chosen so that problems do not occur for logically related parameters, e.g., combinations of adjacent colors. For example, if ranges are selected for color combinations of text and a background color behind the text, color ranges can be chosen automatically so that the text does not disappear visually into the background color.

At stage 3, for example, the request handler 123 can receive a request for content and identify the content item 131a from the eligible content items 131. For example, the request for content can be in the form of a search query received from a browser 204 running on the user device 106 to provide search results in a search results area 206.

At stage 4, for example, the parameter varying engine 124 can prepare the content item, including randomly selecting a value for the parameter that is within the subset of the range for each parameter. In the current example, the values randomly selected for the RGB color components of the result link can be values from the ranges 210-230, 210-250 and 240-255, respectively (e.g., RGB: 230, 230, 250). Also, the values randomly selected for the RGB color components of the visURL can be values from the ranges 212-252, 140-180, and 130-160, respectively (e.g., RGB: 232,168,144).

Other subsequent requests for content 202 that result in selecting the same content item will cause new random selection of the presentation parameters. For example, the next random combination of the six presentation parameters may be RGB=228,241,247 for the result link and RGB: 236,162,145 for the visURL. Over time, the random selection of values for the presentation parameters can be expected to sample different random combinations of colors for the result link and visURL that can be constructed using the six different presentation parameters.

At stage 5, for example, the performance monitoring engine 125 can monitor at least one performance aspect associated with the prepared content item 131a. For example, performance metrics can be obtained and maintained that correspond to different combinations of the presentation parameters.

At stage 6, for example, the experimentation engine 126 can conduct automatic experiments to determine optimal values for the parameters associated with the content item 131a, and adjust the parameters based on the determined optimal values. The experiments can use, for example, the techniques described above for stages 1-5. For example, experiments can use a different set of randomized values for parameters each time the content item 131a is presented in response to the request for content 202. Over time, based on performance metrics associated with the content item 131a and different values of the parameters, optimal values for each of the six parameters can be determined. This can occur, for example, in an iterative process that progressively reduces the sizes of the sub-ranges until optimal values are determined. In some implementations, sub-ranges can be shifted in an iteration, e.g., if performance metrics indicate a best performance near a boundary of the current sub-range.

The stages 2-6 can be repeated. As an example, based on monitoring and using information obtained by the performance monitoring engine 125, the subset of the range can be adjusted iteratively until an optimal value for the variable is determined. The iterations, for example, can successively change (e.g., reduce the size of) the sub-ranges to ranges that are associated with better performance metrics, e.g., than values that are excluded from the sub-ranges. The iterations can occur, for example, on individual parameters (e.g., a thickness of text) or on groups of parameters (e.g., RGB components of a color for an element of a content item). As an example result of running the experiments, optimal values identified for the result link can produce a lavender color (e.g., RGB: 230, 230, 250), and optimal values identified for the visURL can produce a sandy brown color (RGB: 232,168,144).

FIG. 2B shows an example process 250 for experimenting with parameters for presentation of content. In some implementations, engines 121-126 of the content management system 110 can perform automatic steps of the process 250. Manual steps of the process can be performed, for example, by a software engineer, a technician working for a content provider, or some other person.

Defined ranges for parameters, are identified (252). For example, the range identification engine 122 can define ranges of values for parameters and sub-ranges within the ranges of parameters. A range can include all possible values for a parameter, for which a sub-range can include a subset of the range (or a previously-used sub-range) that is selected for experimentation. In some implementations, the ranges of values can be stored in the experimental parameter ranges 132. For example, for the search results example, initial ranges for values associated with RGB color components of the result link color can be 210-250, 210-250 and 240-255, respectively. Also, ranges can be established for the color components of the visURL. Bounding boxes can also be used to define ranges and other parameters (e.g., not related to color) can be selected as well.

In response to requests for content, online randomized experimental value selection occurs (254). At least one content item can be provided including randomly selecting a value for the parameter that is within the subset of the range. For example, for the search results example, the randomly-selected values selected for the RGB components of the result link color can be individual values in the 210-250, 210-250 and 240-255 ranges, respectively. Also, random values can be selected for the color components of the visURL.

Analysis of logs occurs (256), e.g., to determine the results of using values for the parameters, including optionally identifying different sub-ranges of values or a smaller sub-range (i.e., a sub-range that is a subset of the original used sub-range). Logs can include, for example, a historical record of served content and resulting user interactions or other metrics associated with the content. This analysis can be performed, e.g., by the performance monitoring engine 125, which can monitor at least one performance aspect associated with the provided content item, and based on the monitoring, adjust the subset of the range iteratively until an optimal value for the parameter is determined. In the current example, the monitoring can identify which color combinations have performed best for the color combinations of the result links and visURL colors.

A current “best” value is selected and used (258). The value can be a value somewhere within the current range or sub-range of values being used for randomized experiments. In this way, an estimate can be made for an optimal value for the variable in the subset of the range. One example estimate for best values can be RGB=229,242,248 for the result link and RGB=235,161,144 for the visURL. These values can be selected, for example, because they fall within sub-ranges of values that have performed best during experimentation.

An online experiment can be run to test the current “best” value (260). For example, an experiment is run using the estimated optimal value(s), e.g., RGB values of 229, 242 and 248 for the result link and RGB values of 235, 161 and 144 for the visURL.

A current value is launched (262), which places a selected optimal value for the parameter into production (e.g., as a new default value). Launching the value can be a manual process, e.g., by a user who is provided information about the analyzed results relative to different values for a parameter, including information about the performance of online experiments using the current best values.

Online non-experimental value selection occurs (264). For example, values selected and used for presenting content are the current launched values that have been arrived at by automatic experimentation and manually placed into production. At this time, experimentation using current best values and randomized values can stop. In some implementations, occasional experiments can be run using values for parameters that are close to the current launched values in order to find values for parameters that may perform better than the current online versions.

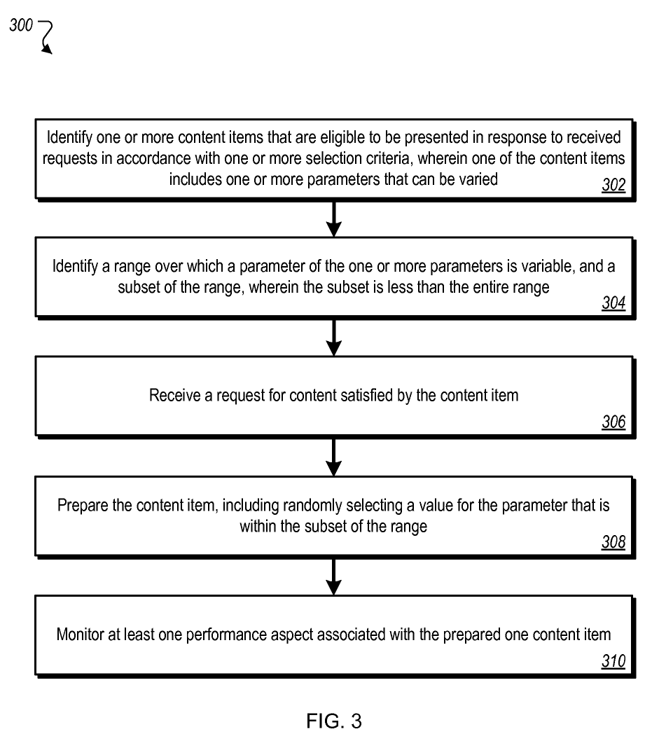

FIG. 3 is a flowchart of an example process 300 for experimenting with values of presentation parameters for content items. In some implementations, the content management system 110 can perform stages of the process 300 using instructions that are executed by one or more processors. FIGS. 1-2B are used to provide example structures for performing the steps of the process 300.

One or more content items are identified that are eligible to be presented in response to received requests in accordance with one or more selection criteria (302). One of the content items includes one or more parameters that can be varied. As an example, the content identification engine 121 can identify the content item 131a (e.g., search results) from the eligible content items 131. In this example, the search results may have six parameters that can be varied, related to the color of the results link and visURL.

In some implementations, the one or more parameters can relate to a presentation aspect of the content item, such as a color of an item, a font width, or a size of a respective content item. Other parameters and presentation aspects can be used. In some implementations, the presentation aspect can be a color of a link or a visual uniform resource locator (visURL) associated with the content item, e.g., identifying how colors in the search results will appear.

A range is identified over which a parameter of the one or more parameters is variable, and a subset of the range is identified, wherein the subset is less than the entire range (304). As an example, the range identification engine 122 can identify initial sub-ranges of values for the RGB components of the results link and visURL. In some implementations, other color spaces (e.g., HSL) can be used.

A request for content is received that is satisfied by the content item (306). The request handler 123, for example, can receive a request for content and identify the content item 131a from the eligible content items 131. The request for content can be, for example, a search query received from a browser 204 running on the user device 106 to provide search results in a search results area 206.

The content item is prepared, including randomly selecting a value for the parameter that is within the subset of the range (308). For example, the parameter varying engine 124 can prepare the content item, including randomly selecting RGB values for the parameters that are within the subsets of the ranges 210-230, 210-250 and 240-255, respectively. An example, combination of values is RGB=230, 230, 250. In some implementations, cookies can be used, e.g., to ensure that the same user receives the same colors.

At least one performance aspect associated with the prepared one content item is monitored (310). For example, the performance monitoring engine 125 can monitor performance metrics associated plural presentations of the prepared content item 131a, each presentation including randomly-chosen values for the color parameters. In some implementations, performance metrics can include aggregate metrics instead of, or in addition to, per content item (e.g., per-ad) metrics.

In some implementations, monitoring can include monitoring revenue or quality metrics based on the randomly-selected values, and the subset of the range can be automatically and iteratively tuned so as to locate an optimal value for the variable. For example, the content management system 110 can track revenue and quality on a per-value-combination basis for the parameters, e.g., to determine a color combination that performs best and for which to select optimal values for each of the six parameters.

In some implementations, the process 300 can further include running an experiment to determine an optimal value for the variable in the subset of the range, and adjusting the parameters associated with the content item based on the determined optimal value. For example, the experimentation engine 126 can conduct automatic experiments to determine optimal values for the parameters associated with the content item 131a, and adjust the parameters based on the determined optimal values. For example, a different set of randomized values for parameters can be used each time the content item 131a is presented. Over time, monitoring can occur for performance metrics associated with the content item 131a and different values of the parameters, and optimal values for each of the six parameters can be determined.

In some implementations, the monitoring can include evaluating whether the content item (e.g., content item 131a) is selected as a winner in a selection process and is presented in response to the received request (e.g., the request for content 202). In some implementations, based on the monitoring, the subset of the range can be adjusted iteratively until an optimal value for the variable is determined, e.g., including optimal values for the six parameters. In some implementations, adjusting the subset of the range can include reducing a size of the subset of the range and repeating the preparing based on received requests that satisfy the selection criteria associated with the content item. For example, the RGB color component ranges can be reduced iteratively, as described above.

In some implementations, the process 300 can further include estimating an optimal value for the variable in the subset of the range, and running an experiment using the estimated optimal value while iterating to determine an actual optimal value based on the adjusting and monitoring. For example, the parameter varying engine 124 can estimate optimal values for the six parameters. The experimentation engine 126 can conduct automatic experiments using the estimates, and information identified by the performance monitoring engine 125 can be used to iteratively adjust the parameters toward parameters that perform best.

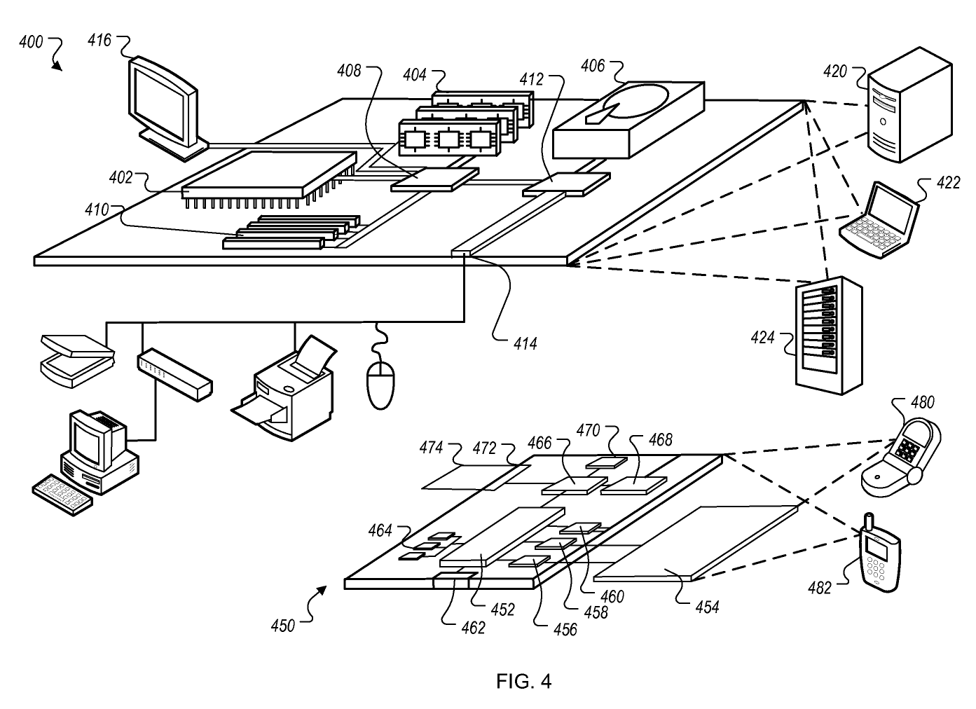

FIG. 4 is a block diagram of example computing devices 400, 450 that may be used to implement the systems and methods described in this document, as either a client or as a server or plurality of servers. Computing device 400 is intended to represent various forms of digital computers, such as laptops, desktops, workstations, personal digital assistants, servers, blade servers, mainframes, and other appropriate computers. Computing device 400 is further intended to represent any other typically non-mobile devices, such as televisions or other electronic devices with one or more processers embedded therein or attached thereto. Computing device 450 is intended to represent various forms of mobile devices, such as personal digital assistants, cellular telephones, smartphones, and other computing devices. The components shown here, their connections and relationships, and their functions, are meant to be examples only, and are not meant to limit implementations of the inventions described and/or claimed in this document.

Computing device 400 includes a processor 402, memory 404, a storage device 406, a high-speed controller 408 connecting to memory 404 and high-speed expansion ports 410, and a low-speed controller 412 connecting to low-speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high-speed controller 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high-speed controller 408 manages bandwidth-intensive operations for the computing device 400, while the low-speed controller 412 manages lower bandwidth-intensive operations. Such allocation of duties is an example only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed bus 414. The low-speed bus 414 (e.g., a low-speed expansion port), which may include various communication ports (e.g., USB, Bluetooth®, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as computing device 450. Each of such devices may contain one or more of computing devices 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The computing device 450 may also be provided with a storage device, such as a micro-drive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the computing device 450, such as control of user interfaces, applications run by computing device 450, and wireless communication by computing device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provided in communication with processor 452, so as to enable near area communication of computing device 450 with other devices. External interface 462 may provide, for example, for wired communication (e.g., via a docking procedure) or for wireless communication (e.g., via Bluetooth® or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to computing device 450 through expansion interface 472, which may include, for example, a subscriber identification module (SIM) card interface. Such expansion memory 474 may provide extra storage space for computing device 450, or may also store applications or other information for computing device 450. Specifically, expansion memory 474 may include instructions to carry out or supplement the processes described above, and may include secure information also. Thus, for example, expansion memory 474 may be provide as a security module for computing device 450, and may be programmed with instructions that permit secure use of computing device 450. In addition, secure applications may be provided via the SIM cards, along with additional information, such as placing identifying information on the SIM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Computing device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through transceiver 468 (e.g., a radio-frequency transceiver). In addition, short-range communication may occur, such as using a Bluetooth®, WiFi, or other such transceiver (not shown). In addition, GPS receiver module 470 may provide additional wireless data to computing device 450, which may be used as appropriate by applications running on computing device 450.

Computing device 450 may also communicate audibly using audio codec 460, which may receive spoken information from a user and convert it to usable digital information. Audio codec 460 may likewise generate audible sound for a user, such as through a speaker, e.g., in a handset of computing device 450. Such sound may include sound from voice telephone calls, may include recorded sound (e.g., voice messages, music files, etc.) and may also include sound generated by applications operating on computing device 450.

The computing device 450 may be implemented in a number of different forms, as shown in the figure. For example, it may be implemented as a cellular telephone 480. It may also be implemented as part of a smartphone 482, personal digital assistant, or other mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. Other programming paradigms can be used, e.g., functional programming, logical programming, or other programming. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
identifying, by a content management system, a particular content item that is eligible to be presented in response to received requests in accordance with one or more selection criteria, wherein the particular content item includes one or more parameters that can be varied by the content management system to vary visual presentation of the particular content item when presented in response to the received requests;
for the particular content item, identifying, by the content management system, a range of values over which a parameter of the one or more parameters is variable to vary visual presentation of the particular content item;
establishing multiple different disjoint subsets of the range, wherein the subsets are each less than an entire amount of the range;
receiving, from one or more client devices associated with users, multiple different requests for content;
selecting, by the content management system, the particular content item for presentation at the one or more client devices in response to each of the multiple different requests;
preparing, by the content management system and prior to delivering the particular content item to the one or more client devices, the particular content item for presentation in response to each of the multiple different requests, including changing, for each request, a visual characteristic of the particular content item for each of at least two or more of the multiple different requests by randomly selecting, for the parameter that varies visual presentation of the particular content item, a different value from the subsets of the range;
providing the particular content item, as prepared for each request, to the one or more client devices;
analyzing results of providing the particular content item with each different value of the parameter that varies visual presentation of the particular content item, the results identifying at least one performance of the particular content item when presented with the changed visual characteristics corresponding to the different values of the parameter when changed, wherein the at least one performance includes a click through rate for the particular content item when presented; and
adjusting, based on the analyzing, the subsets that are used in subsequent iterations of the preparing, providing, and analyzing to select the different value of the parameter that varies the visual presentation of the particular content item, including in each of two or more of the subsequent iterations, reducing a size of at least one of the subsets of values from which the random selection is performed based on the analyzing.

2. The method of claim 1 wherein the one or more parameters relate to a visual presentation aspect of the particular content item.

3. The method of claim 2 wherein the visual presentation aspect is selected from a group comprising a color of an item, a font width, or a size of the particular content item.

4. The method of claim 2 wherein the visual presentation aspect is a color of a link or a visual uniform resource locator (visURL) associated with the particular content item.

5. The method of claim 1 further comprising running an experiment to determine an optimal value for the parameter in the subsets of the range, and adjusting the parameters associated with the particular content item based on the determined optimal value.

6. (canceled)

7. The method of claim 1, wherein adjusting the subsets includes adjusting the subsets of the range iteratively until an optimal value for the parameter is determined.

8. The method of claim 7, wherein adjusting the subsets of the range includes iteratively reducing a size of the subsets of the range and repeating the preparing based on received requests that satisfy the selection criteria associated with the particular content item.

9. The method of claim 7, further comprising estimating an optimal value for the parameter in the subsets of the range, and running an experiment using the estimated optimal value while iterating to determine an actual optimal value based on the adjusting and monitoring.

10. The method of claim 1, wherein analyzing the results includes monitoring revenue or quality metrics based on the randomly-selected different values, and wherein adjusting the subsets includes automatically tuning the subsets of the range iteratively so as to locate an optimal value for the parameter.

11. A computer program product embodied in a non-transitory computer-readable medium including instructions, that when executed, cause one or more processors to:
identify, by a content management system, a particular content item that is eligible to be presented in response to received requests in accordance with one or more selection criteria, wherein the particular content item includes one or more parameters that can be varied by the content management system to vary visual presentation of the particular content item when presented in response to the received requests;
for the particular content item, identify, by the content management system, a range of values over which a parameter of the one or more parameters is variable to vary visual presentation of the particular content item;
establish multiple different disjoint subsets of the range, wherein the subsets are each less than an entire amount of the range;
receive, from one or more client devices associated with users, multiple different requests for content;
select, by the content management system, the particular content item for presentation at the one or more client devices in response to each of the multiple different requests;
prepare, by the content management system and prior to delivering the particular content item to the one or more client devices, the particular content item for presentation in response to each of the multiple different requests, including changing, for each request, a visual characteristic of the particular content item for each of at least two or more of the multiple different requests by randomly selecting, for the parameter that varies visual presentation of the particular content item, a different value from the subsets of the range;
provide the particular content item, as prepared for each request, to the one or more client devices;
analyze results of providing the particular content item with each different value of the parameter that varies visual presentation of the particular content item, the results identifying at least one performance of the particular content item when presented with the changed visual characteristics corresponding to the different values of the parameter when changed, wherein the at least one performance includes a click through rate for the particular content item when presented; and
adjust, based on the analyzing, the subsets that are used in subsequent iterations of the preparing, providing, and analyzing to select the different value of the parameter that varies the visual presentation of the particular content item, including in each of two or more of the subsequent iterations, reducing a size of at least one of the subsets of values from which the random selection is performed over multiple iterations based on the analyzing.

12. The computer program product of claim 11, further comprising steps to run an experiment to determine an optimal value for the parameter in the subsets of the range, and adjusting the parameters associated with the particular content item based on the determined optimal value.

13. The computer program product of claim 11, wherein the adjusting includes adjusting the subsets of the range iteratively until an optimal value for the parameter is determined.

14. The computer program product of claim 13, wherein adjusting the subsets of the range includes iteratively reducing a size of the subsets of the range and repeating the preparing based on received requests that satisfy the selection criteria of the associated with the particular content item.

15. The computer program product of claim 11, wherein analyzing the results includes monitoring revenue or quality metrics based on the randomly-selected different values, and wherein adjusting the subsets includes automatically tuning the subsets of the range iteratively so as to locate an optimal value for the parameter.

16. A system comprising:
a content identification engine for identifying a particular content item that is eligible to be presented in response to received requests in accordance with one or more selection criteria, wherein the particular content item includes one or more parameters that can be varied by the system to vary visual presentation of the particular content item when presented in response to the received requests;
a range identification engine for identifying, for the particular content item, a range of values over which a parameter of the one or more parameters is variable to vary visual presentation of the particular content item, and establishing multiple different disjoint subsets of the range, wherein the subsets are each less than an entire amount of the range;
a request handler for receiving, from one or more client devices associated with users, multiple different requests for content, and selecting the particular content item for presentation at the one or more client devices in response to each of the multiple different requests;
a parameter varying engine for preparing, prior to delivering the particular content item to the one or more client devices, the particular content item for presentation in response to each of the multiple different requests, including changing, for each request, a visual characteristic of the particular content item for each of at least two or more of the multiple different requests by randomly selecting, for the parameter that varies visual presentation of the particular content item, a different value from the subsets of the range, and after the particular content item is prepared, the request handler providing the particular content item, as prepared for each request, to the one or more client devices; and
a performance monitoring engine for:
analyzing results of providing the particular content item with each different value of the parameter that varies visual presentation of the particular content item, the results identifying at least one performance of the particular content item when presented with the changed visual characteristics corresponding to the different values of the parameter when changed, wherein the at least one performance includes a click through rate for the particular content item when presented; and
adjusting, based on the analyzing, the subsets that are used in subsequent iterations of the preparing, providing, and analyzing to select the different value of the parameter that varies the visual presentation of the particular content item, including in each of two or more of the subsequent iterations, reducing a size of at least one of the subsets of values from which the random selection is performed based on the analyzing.

17. The system of claim 16, further comprising an experimentation engine for running an experiment to determine an optimal value for the parameter in the subsets of the range and, based on monitoring, adjusting the parameters associated with the particular content item based on the determined optimal value.

18. The system of claim 16, wherein the adjusting includes adjusting the subsets of the range iteratively until an optimal value for the parameter is determined.

19. The system of claim 18, wherein adjusting the subsets of the range includes iteratively reducing a size of the subsets of the range and repeating the preparing based on received requests that satisfy the selection criteria of the associated with the particular content item.

20. The system of claim 16, wherein analyzing the results includes monitoring revenue or quality metrics based on the randomly-selected different values, and wherein adjusting the subsets includes automatically tuning the subsets of the range iteratively so as to locate an optimal value for the parameter.
